(19) United States
(12) Patent Application Publication
(10) Pub. No.: US 2005/0153107 A1
(43) Pub. Date: Jul. 14, 2005

(54) Substrate having functional layer pattern formed thereon and method of forming functional layer pattern

(75) Inventor: Tadayoshi Iijima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/754,620

(22) Filed: Jan. 12, 2004

(51) Int. Cl. B32B 3/00

(52) U.S. Cl. 428/195.1

(57) ABSTRACT

A method of forming a functional layer pattern capable of demonstrating various functions, for example, a transparent conductive layer pattern having a low electric resistance value is provided. A method of forming a functional layer pattern, comprises the steps of: (A) preparing a functional film for transfer, having a functional layer formed on a support, the functional layer being releasable from the support and being composed of a compressed layer of functional fine particles; (B) attaching the functional film for transfer onto a surface of the substrate through a photosensitive adhesive layer so that the support is outwardly oriented; (C) pattern-exposing the photosensitive adhesive layer so that the photosensitive adhesive layer is patterned into a cured region and an uncured region and then adhering the functional layer corresponding to the cured region onto the surface of the substrate through the adhesive layer; and (D) releasing the support from the substrate so as to leave a functional layer on the substrate in the cured region while releasing a functional layer from the substrate together with the support in the uncured region.

### BACKGROUND OF THE INVENTION

1. Field of the Invention

The present invention relates to a substrate having a functional layer pattern formed thereon and a method of forming a functional layer pattern. More specifically, the present invention relates to a substrate having a functional layer pattern formed thereon, which is obtained by using a functional film for transfer including a functional layer comprising a compressed layer of functional fine particles on a support, and a method of forming a functional layer pattern on a substrate by using the functional film for transfer including a functional layer comprising a compressed layer of functional fine particles on a support.

In the present invention, the functional film includes both a functional film and a functional sheet. In addition, the functional film includes a functional film in which a support is a metal.

The functional layer is a layer having a function, and the function means an action accomplished through physical and/or chemical phenomena. The functional layer includes layers having various functions, such as a conductive layer, an ultraviolet shielding layer, an infrared shielding layer, a magnetic layer, a ferromagnetic layer, a dielectric layer, a ferroelectric layer, an electrochromic layer, an electroluminescent layer, an insulating layer, a light-absorbing layer, a light selecting absorbing layer, a reflecting layer, a reflection preventing layer, a catalyst layer, a photocatalyst layer and others.

In particular, the present invention relates to a substrate having a transparent conductive layer pattern formed thereon and to a method of forming a transparent conductive layer pattern on a substrate. The transparent conductive layer pattern can be used as a transparent electrode such as an electroluminescent panel electrode, an electrochromic element electrode, a liquid crystal electrode, a transparent plane heating element, and a touch panel. In addition, the transparent conductive layer pattern can be used as a transparent antenna.

2. Disclosure of the Related Art

Hitherto, functional layers made of various functional materials are produced by the physical vapor deposition method (PVD) such as vacuum vapor deposition, laser ablation, sputtering, or ion plating, or by the chemical vapor deposition method (CVD) such as heat CVD, light CVD, or plasma CVD. These generally require a large-scale apparatus, and among these, some are not suited for forming a layer of large area.

For example, with respect to a transparent conductive layer, the following description can be made. At present, the transparent conductive layer is produced mainly by the sputtering method. There are various modes for the sputtering method, for example, a method of forming a layer by allowing inert gas ions, which are generated by direct current or high-frequency discharge, to be accelerated to hit the surface of a target in vacuum so as to strike out atoms constituting the target from the surface for deposition on the substrate surface. The sputtering method is excellent in that a conductive layer having a low surface electric resistance can be formed even if it has a large area to some extent. However, it has a disadvantage that the apparatus is large, and the layer forming speed is slow. If the conductive layer is to have a still larger area from now on, the apparatus will be further enlarged. This raises a technical problem such that the controlling precision must be heightened and, from another point of view, raises a problem of increase in the production cost. Further, although the number of targets is increased to raise the speed in order to compensate for the slowness of the layer forming speed, this also is a factor that enlarges the apparatus, thereby raising a problem.

The transparent conductive layer obtained by the sputtering method is etched to obtain a transparent conductive layer pattern. A method for easily obtaining a large-area transparent conductive layer pattern is desired to be developed.

As a method of obtaining a conductive layer pattern, the following method is conceived; a conductive coating material, in which conductive fine particles are dispersed in a binder solution, is pattern-applied onto a substrate by screen printing, and then is dried and cured to form a conductive layer pattern. The screen printing is advantageous in that: a large-area conductive layer pattern can be easily formed; a device for fabrication is simple and the productivity is high; and a conductive layer pattern can be fabricated at lower cost than by sputtering. In the application method, the conductive fine particles contact with each other to form an electric path, resulting in demonstration of conductivity. However, the conductive layer fabricated by a conventional application method is disadvantageous in that the contact between conductive fine particles is insufficient, resulting in an elevated electric resistance value of the obtained conductive layer (i.e., having poor conductivity). Consequently, the applications of the conductive layer are limited.

In addition, another method as follows is conceivable as a method of obtaining a conductive layer pattern. A conductive coating material without containing a binder, comprising a tin-doped indium oxide (ITO) powder, a solvent, a coupling agent, and an organic acid salt or an inorganic acid salt of a metal, is used and pattern-applied onto a substrate by screen printing. Thereafter, the applied conductive coating material is calcined at, for example, 300° C. or higher to form a conductive layer pattern. Since this method does not use any binder, an electric resistance value of the conductive layer is lowered. However, since this method needs the sintering step at 300° C. or higher, it is difficult to form a conductive layer pattern on a substrate such as a resin film. More specifically, a resin film is melt, carbonized or burnt at a high temperature. Although the highest limit of temperature depends on the type of resin film, a polyethylene terephthalate (PET) film, for example, may have the highest limit temperature of 130° C.

By the application method, in the case that the substrate is one having flexibility such as a film, a functional layer having a large area can be easily formed. However, in the case that the substrate is one having poor flexibility such as a plate material, the application is difficult as compared with the case of the flexible substrate, and particularly it is difficult to control a layer thickness for uniformity.

Namely, in the case of the flexible film, the application can be performed by fixing a coater section and moving the film, thereby easily controlling a layer thickness. On the other hand, in the case of the plate material having poor flexibility, although the application can be 1o performed by moving the plate material if the application area is small, accuracy of the layer thickness is liable to deteriorate due to wobbling or others by moving the plate material if the application area is large. Also, although a method moving the coater section may be mentioned, accuracy of the layer thickness deteriorates if flatness of the plate material is poor.

In order to form a functional layer pattern on a substrate having poor flexibility, a method of patterning the functional layer formed on a flexible film support while transferring the formed functional layer onto the substrate having poor flexibility is conceived.

For example, Japanese Patent Laid-Open Publication No. Hei 10-36143 discloses a method of forming a thick film pattern, comprising the steps of: (1) forming an adhesive photosensitive resin layer on a substrate; (2) pattern-exposing the photosensitive resin layer to light so as to pattern the photosensitive resin layer into an adhesive uncured portion and a cured portion having no longer any adhesiveness; (3) laminating a sheet for transfer, which is formed by providing a pattern formation layer on a base film, onto the substrate so that the side of the transfer sheet where the pattern formation layer is provided faces the photosensitive resin layer; (4) removing the transfer sheet so as to leave a portion of the pattern formation layer corresponding to the uncured portion of the photosensitive resin layer on the substrate; and (5) calcining the entire substrate to burn down the photosensitive resin layer while bringing the remaining portion of the pattern formation layer into adhesion to the substrate. The above-cited patent publication also discloses the other methods of forming a thick film pattern.

According to the method described in the above patent publication, a thick film pattern is formed on a substrate having poor flexibility. However, it is necessary to calcine the entire substrate at such a high temperature that the photosensitive resin layer may be burnt down so as to bring the pattern formation layer into adhesion to the substrate. The calcining at a high temperature adversely affects the substrate and the pattern formation layer.

### SUMMARY OF THE INVENTION

In view of such a background, it is expected to develop a method allowing the formation of a large-area functional layer pattern capable of demonstrating various functions, for example, a transparent conductive layer pattern having a low electrical resistance value, even on a substrate having poor flexibility in an easy manner at low cost without sintering or calcining at a high temperature.

The present invention has an object of providing a method of forming a functional layer pattern capable of demonstrating various functions, for example, a transparent conductive layer pattern having a low electric resistance value. The object of the present invention is, in particular, to provide a method of forming a functional layer pattern having a uniform thickness on a substrate having poor flexibility such as a plate material.

Another object of the present invention is to provide a substrate having the functional layer pattern formed thereon.

The inventor of the present invention has found out that various functional layer patterns can be easily formed by use of a functional film for transfer at low cost without sintering or calcining at a high temperature, the functional film for transfer having at least a functional layer on a support, the functional layer being releasable from the support and corresponding to a compressed layer of functional fine particles, thereby achieving the present invention. The above-described functional film for transfer is a novel one developed by the inventor of the present invention.

The present invention provides a substrate having a functional layer pattern formed thereon, the functional layer pattern being formed on the substrate through an adhesive layer, wherein the functional layer is a compressed layer of functional fine particles.

The functional layer is selected from the group consisting of: a conductive layer; an ultraviolet shielding layer; an infrared shielding layer; a magnetic layer; a ferromagnetic layer; a dielectric layer; a ferroelectric layer; an electrochromic layer; an electroluminescent layer; an insulating layer; a light-absorbing layer; a light selecting absorbing layer; a reflecting layer; a reflection preventing layer; a catalyst layer; and a photocatalyst layer.

The first method of forming a functional layer pattern according to the present invention, comprises the steps of:
(A) preparing a functional film for transfer having at least a functional layer on a support, the functional layer being releasable from the support and being a compressed layer of functional fine particles;
(B) attaching the functional film for transfer onto a surface of the substrate through a photosensitive adhesive layer so that the support is outwardly oriented;
(C) pattern-exposing the photosensitive adhesive layer so as to pattern the photosensitive adhesive layer into a cured region and an uncured region, to adhere the functional layer corresponding to the cured region to the surface of the substrate through the cured adhesive layer; and
(D) releasing the support from the substrate, so that in the cured region of the adhesive layer the functional layer remains on the substrate whereas in the uncured region of the adhesive layer the functional layer is released from the substrate together with the support.

In the first method of forming a functional layer pattern, it is preferred that the functional film for transfer has the photosensitive adhesive layer on the functional layer. In the case where the photosensitive adhesive layer is not formed in the functional film for transfer, it is suitable to provide a photosensitive adhesive layer on the substrate in advance.

In the first method of forming a functional layer pattern, adhesion strength between the support and the releasable functional layer in the functional film for transfer is smaller than that between the adhesive layer and the surface of the substrate in the cured region of the adhesive layer, and is larger than that between the adhesive layer and the surface of the substrate in the uncured region of the adhesive layer.

In the first method of forming a functional layer pattern, in the case where a part of the uncured adhesive layer remains on the substrate in the uncured region of the adhesive layer after the step of releasing the support from the substrate, it is suitable to perform the step of removing the part of the uncured adhesive layer remaining on the substrate as needed.

In the first method of forming a functional layer pattern, in the case where a part of the uncured adhesive layer and a part of the functional layer remain on the substrate in the uncured region of the adhesive layer after the step of releasing the support from the substrate, it is suitable to perform the step of removing the part of the functional layer remaining on the substrate together with the remaining part of the uncured adhesive layer as needed.

The second method of forming a functional layer pattern according to the present invention, comprises the steps of:
(A) preparing a functional film for transfer having at least a functional layer on a support, and a photosensitive adhesive layer provided on the functional layer, the functional layer being releasable from the support and being a compressed layer of functional fine particles;
(F) previously pattern-exposing the photosensitive adhesive layer so as to pattern the photosensitive adhesive layer into a cured region no longer having adhesiveness and an uncured region maintaining adhesiveness;
(G) attaching the patterned functional film for transfer onto a surface of the substrate through the adhesive layer in the uncured region so that the support is outwardly oriented;
(H) exposing the adhesive layer in the uncured region for curing, to adhere the functional layer corresponding to the cured region after the attachment step onto the surface of the substrate; and
(I) releasing the support from the substrate, so that in the cured region after the attachment step of the adhesive layer the functional layer remains on the substrate whereas in the precured region of the adhesive layer the functional layer is released from the substrate together with the support.

In the second method of forming a functional layer pattern, adhesion strength between the support and the releasable functional layer in the functional film for transfer is smaller than that between the adhesive layer and the surface of the substrate in the cured region after the attachment step of the adhesive layer, and is larger than that between the adhesive layer and the surface of the substrate in the precured region of the adhesive layer.

The third method of forming a functional layer pattern according to the present invention, comprises the steps of:
(A) preparing a functional film for transfer, having at least a functional layer on a support, the functional layer being releasable from the support and being a compressed layer of functional fine particles;
(K) forming a patterned adhesive layer on a surface of the substrate by application;
(L) attaching the functional film for transfer onto a surface of the substrate through the adhesive layer formed on the surface of the substrate so that the support is outwardly oriented;
(M) curing the adhesive layer, so that the functional layer in a region where the adhesive layer is formed is adhered onto the surface of the substrate through the cured adhesive layer; and
(N) releasing the support from the substrate, so that in the region where the adhesive layer is formed the functional layer remains on the substrate whereas in a region where the adhesive layer is not formed the functional layer is released from the substrate together with the support.

In the third method of forming a functional layer pattern, a photosensitive adhesive or a thermally curable adhesive may be used as an adhesive. In the case where the adhesive is a photosensitive adhesive, the adhesive layer is cured by exposure to light at the step (M). On the other hand, in the case where the adhesive is a thermally curable adhesive, the adhesive layer is cured by heating at the step (M).

In the third method of forming a functional layer pattern, adhesion strength between the support and the releasable functional layer in the functional film for transfer is smaller than that between the cured adhesive layer and the surface of the substrate in the region where the adhesive layer is formed.

In the first, second, and third methods of forming a functional layer pattern, the functional film for transfer normally includes an intermediate layer between the support and the functional layer.

Whether the intermediate layer exists on the functional layer or the functional layer is exposed after the release of the support in pattern-transfer depends on the degree of adhesion between the intermediate layer and the support and the degree of adhesion between the intermediate layer and the functional layer.

In the first, second, and third methods of forming a functional layer pattern, the compressed layer of functional fine particles in the functional film for transfer is obtained by applying and drying a liquid, in which the functional fine particles are dispersed, onto the support or the intermediate layer provided on the support to form a functional fine particle-containing layer and then compressing the functional fine particle-containing layer.

In the first, second, and third methods of forming a functional layer pattern, it is preferred that the compressed layer of functional fine particles is obtained by compressing at a compressive force of 44 N/mm² or larger.

In the first, second, and third methods of forming a functional layer pattern, the compressed layer of functional fine particles is, for example, a transparent conductive layer.

According to the present invention, a functional film for transfer including a functional layer having excellent performance is produced by simple processes such as application and compression. Then, a method of forming a functional layer pattern capable of demonstrating various functions, for example, a transparent conductive layer pattern having a low electrical resistance value, by using the obtained functional film for transfer, is provided. In addition, a substrate, on which a functional layer pattern composed of a compressed layer of functional fine particles is formed, is provided.

### BRIEF DESCRIPTION OF THE DRAWINGS

FIG. 1 is a sectional view showing an example of a functional film used in the present invention;

FIG. 2 is a sectional view showing an example of the functional film used in the present invention;

FIG. 3 is a sectional view showing an example of the functional film used in the present invention;

FIG. 4 is a sectional view showing an example of the functional film used in the present invention;

FIG. 5 is a sectional view showing an example of the functional film used in the present invention;

FIGS. 6(A) to 6(E) are schematic flowcharts showing the first method of forming the functional layer pattern of the present invention;

FIGS. 7(A) to 7(J) are schematic flowcharts showing the second method of forming the functional layer pattern of the present invention; and

FIGS. 8(A) to 8(0) are schematic flowcharts showing the third method of forming the functional layer pattern of the present invention.

### DETAILED DESCRIPTION OF THE INVENTION

A functional film for transfer used in the present invention is described.

Conventionally, in the application method, it was considered that a functional layer cannot be formed without the use of a large amount of a binder resin, or in the case where the binder resin is not used, the functional layer cannot be obtained unless a functional substance is sintered at a high temperature.

With respect to a conductive layer, it was considered that the conductive layer cannot be formed without the use of a large amount of a binder resin, or in the case where the binder resin is not used, the conductive layer cannot be obtained unless a conductive substance is sintered at a high temperature.

Nevertheless, surprisingly as a result of eager studies made by the present inventor, it has been found out that a functional layer having mechanical strength and being capable of exhibiting various functions can be obtained by compression even without the use of a large amount of the binder resin and without calcining at a high temperature. The present inventor has found out that a transparent conductive layer having a low resistance value can be obtained with the use of a conductive material.

Further, the present inventor has found out that a functional film for transfer can be obtained by forming a functional layer on a support in a state in which the functional layer is releasable from the support.

The functional film for transfer has at least a functional layer on a support, the functional layer being releasable from the support and being a compressed layer of functional fine particles. The functional film for transfer normally has an intermediate layer between the support and the functional layer.

The functional film for transfer has two forms, depending on the exposure/unexposure of a transferred surface of a functional layer when the functional layer is pattern-transferred onto the substrate.

The first form of functional film for transfer, in which the surface of the functional layer is not exposed, will be described below.

The first form of film is the functional film for transfer which has: an intermediate layer formed on the support, the intermediate layer being releasable from the support; and the compressed layer of functional fine particles, formed on the releasable intermediate layer, wherein the releasable intermediate layer is releasable from the support together with the compressed layer of functional fine particles. If the functional layer is pattern-transferred onto the substrate by using the first form of functional film, a functional layer pattern is formed on the surface of the substrate while the releasable intermediate layer is present on the functional layer.

In the first form of functional film for transfer, the intermediate layer releasable from the support is not particularly limited as long as it is constituted to have the above-described function at the time of transfer. More specifically, however, it is preferred that the first form of functional film for transfer has the following structure.

In the first form of functional film for transfer, the releasable intermediate layer may include a resin layer composed mainly of resin. The resin layer is releasable from the support together with the compressed layer of functional fine particles.

In the first form of functional film for transfer, the releasable intermediate layer may include a hard-coating layer formed on the support and the resin layer formed on the hard-coating layer. The hard-coating layer is releasable from the support together with the resin layer and the compressed layer of functional fine particles.

The second form of functional film for transfer, in which the surface of the functional layer is exposed, will be described below.

The second form of film is the functional film for transfer which has: a base layer formed on the support; and the compressed layer of functional fine particles formed on the base layer, wherein the compressed layer of functional fine particles is releasable from the base layer.

The base layer is not substantially released from the support at the time of transfer. In other words, the second form of film is the functional film for transfer which has: an intermediate layer formed on the support, the intermediate layer being unreleased from the support; and the compressed layer of functional fine particles on the unreleased intermediate layer, wherein the compressed layer of functional fine particles is releasable from the support and the unreleased intermediate layer.

If the functional layer is pattern-transferred onto the substrate by using the second form of functional film, the functional layer pattern is formed on the surface of the substrate while the surface of the functional layer is exposed.

In the second form of functional film, the base layer, that is, the unreleased intermediate layer may be a resin layer composed mainly of resin.

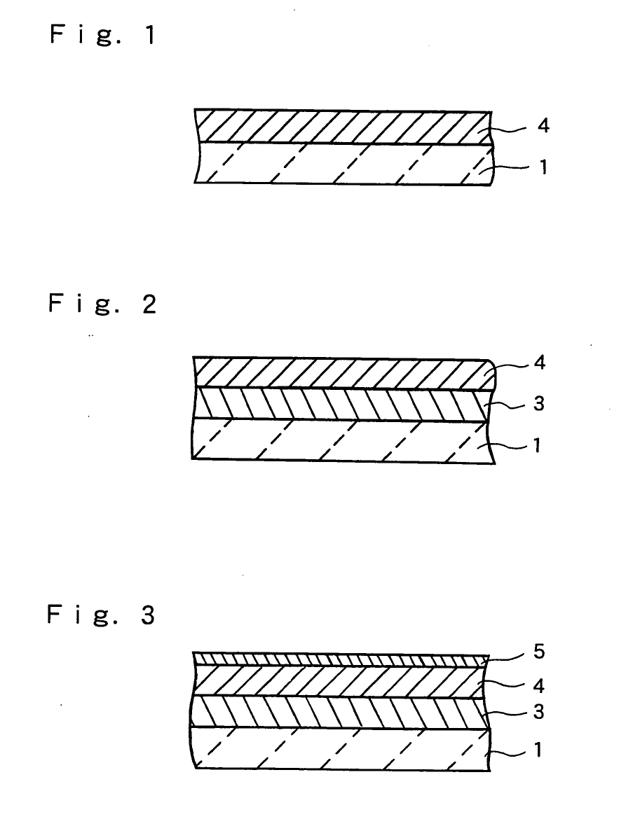

With reference to the accompanying drawings, the functional film for transfer (hereinafter, also referred to simply as a functional film) will be described. Some examples of layer structure of the first and the second forms of functional film for transfer will be shown in FIGS. 1 to 5.

FIG. 1 is a sectional view showing an example of layer structure of a functional film in which a functional layer 4 is formed on a support 1. In this case, the surface of the support 1 on the side where the functional layer 4 is provided is subjected to a release treatment.

FIG. 2 is a sectional view showing an example of layer structure of a functional film in which a resin layer 3 and the functional layer 4 are formed on the support 1 in this order. The resin layer 3 corresponds to the releasable intermediate layer in the first form of film, whereas it corresponds to the base layer, that is, the unreleased intermediate layer in the second form of film. In the case of the first form, the surface of the support 1 on the side where the resin layer 3 is provided is subjected to a release treatment. In the releasing step of pattern-transfer, release occurs between the support 1 and the resin layer 3 in a region where the functional layer pattern is formed. In the case of the second form, the adhesion between the support 1 and the resin layer 3 is strong. In the releasing step of the pattern-transfer, release occurs between the resin layer 3 and the functional layer 4 in a region where the functional layer pattern is formed.

The region where the functional layer is formed corresponds to a cured region of a photosensitive adhesive layer in the first method of forming the functional layer pattern according to the present invention, described below. The region where the functional layer is formed corresponds to a cured region of the photosensitive adhesive layer after an attachment step in the second method of forming the functional layer pattern according to the present invention, whereas it corresponds to a region where the photosensitive adhesive layer is formed in the third method of forming the functional layer pattern according to the present invention.

FIG. 3 is a sectional view showing an example of layer structure of the functional film including the resin layer 3, the functional layer 4, and a photosensitive adhesive layer 5 formed on the support 1 in this order. Specifically, the adhesive layer 5 is further formed on the functional layer 4 in FIG. 2. In the case of the first form, at the releasing step of pattern-transfer, release occurs between the support 1 and the resin layer 3 in the region where the functional layer pattern is formed. In the case of the second form, at the releasing step of pattern-transfer, release occurs between the resin layer 3 and the functional layer 4 in the region where the functional layer pattern is formed.

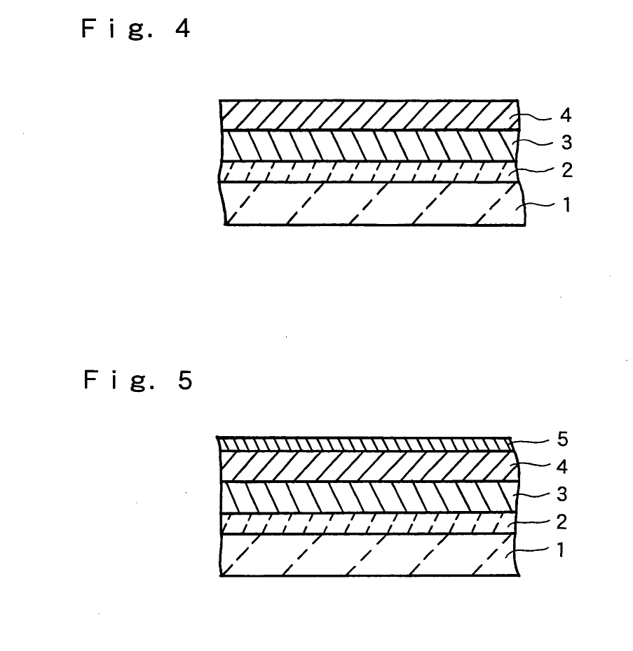

FIG. 4 is a sectional view showing an example of layer structure of the first form of functional film in which a hard-coating layer 2, the resin layer 3, and the functional layer 4 are formed on the support 1 in this order. In this case, the surface of the support 1 on the side where the hard-coating layer 2 is provided may be subjected to a releasing treatment or may not be subjected to a releasing treatment. At the releasing step of pattern-transfer, release occurs between the support 1 and the hard-coating layer 2 in the region where the functional layer pattern is formed.

FIG. 5 is a sectional view showing an example of layer structure of the first form of functional film in which the hard-coating layer 2, the resin layer 3, the functional layer 4, and the photosensitive adhesive layer 5 are formed on the support 1 in this order. More specifically, the adhesive layer 5 is further formed on the functional layer 4 in FIG. 4. In this case, the surface of the support 1 on the side where the hard-coating layer 2 is provided may be subjected to a releasing treatment or may not be subjected to a releasing treatment. At the releasing step of pattern-transfer, release occurs between the support 1 and the hard-coating layer 2 in the region where the functional layer pattern is formed.

In the present invention, the functional layer 4 is not particularly limited, and includes layer having various functions such as a conductive layer, an ultraviolet shielding layer, an infrared shielding layer, a magnetic layer, a ferromagnetic layer, a dielectric layer, a ferroelectric layer, an electrochromic layer, an electroluminescent layer, an insulating layer, a light-absorbing layer, a light selecting absorbing layer, a reflecting layer, a reflection preventing layer, a catalyst layer, a photocatalyst layer and the like. Therefore, in the present invention, functional fine particles are used to constitute the aforesaid intended layer. The functional fine particles to be used are not particularly limited and may be mainly inorganic fine particles having an agglomeration force. In the production of any of the functional films, by applying a method of the present invention, a functional coating layer having a sufficient mechanical strength can be obtained, and the disadvantage, caused by a binder resin in the conventional application method that makes use of a large amount of the binder resin, can be eliminated. As a result, the intended function is further improved.

For example, in the production of a transparent conductive layer, conductive inorganic fine particles are used such as tin oxide, indium oxide, zinc oxide, cadmium oxide, antimony-doped tin oxide (ATO), fluorine-doped tin oxide (FTO), tin-doped indium oxide (ITO), aluminum-doped zinc oxide (AZO), or the like. In view of obtaining a more excellent conductivity, ITO is preferable. Alternatively, those in which the surface of fine particles such as barium sulfate having transparency is coated with an inorganic material such as ATO, ITO, or the like may be used. The particle diameter of these fine particles differs depending on the degree of scattering required in accordance with the usage of the conductive film, and may generally vary depending on the shape of the particles; however, it is generally 10 μm or less, preferably 1.0 μm or less, more preferably from 5 nm to 100 nm.

Alternatively, organic conductive fine particles may be used. As the organic conductive fine particles, for example, those in which the surface of the resin fine particles is coated with a metal material, and others may be mentioned.

By application of the production method in the present invention, an excellent conductivity is obtained. In the present invention, transparency means transmittance of visible light. With respect to the degree of scattering of light, desired level differs depending on the usage of the conductive layer. In the present invention, those generally referred to as being translucent and having a scattering are also included.

In the production of the ferromagnetic layer, iron oxide type magnetic powders such as γ-Fe₂O₃, Fe₃O₄, Co—FeOx, Ba ferrite, etc., ferromagnetic alloy powders containing a ferromagnetic metal element such as α-Fe, Fe—Co, Fe—Ni, Fe—Co—Ni, Co, Co—Ni, etc. as a major component, or the like is used. By application of the production method in the present invention, the saturation magnetic flux density of the magnetic coating layer is improved.

In the production of the dielectric layer or the ferroelectric layer, dielectric or ferroelectric fine particles such as magnesium titanate type, barium titanate type, strontium titanate type, lead titanate type, lead titanate zirconate type (PZT), lead zirconate type, lanthanum-doped lead titanate zirconate type (PLZT), magnesium silicate type, a lead-containing perovskite compound, or the like are used. By application of the production method in the present invention, dielectric properties or ferroelectric properties are improved.

In the production of a metal oxide layer that exhibits various functions, fine particles of metal oxide such as iron oxide (Fe₂O₃), silicon oxide (SiO₂), aluminum oxide (Al₂O₃), titanium dioxide (TiO₂), titanium oxide (TiO), zinc oxide (ZnO), zirconium oxide (ZrO₂), tungsten oxide (WO₃), or the like are used. By application of the production method in the present invention, the packing density of metal oxide in the layer increases to improve various functions. For example, if SiO₂ or Al₂O₃ carrying a catalyst is used, a porous catalyst layer having a practicable strength is obtained. If TiO₂ is used, a photocatalyst function is improved. Further, if WO₃ is used, an improvement of chromophoric action in an electrochromic display element is obtained.

Further, in the production of the electroluminescent layer, fine particles of zinc sulfide (ZnS) are used. By application of the production method in the present invention, an inexpensive electroluminescent layer can be produced by the application method.

In the present invention, a liquid in which functional fine particles selected from the above-mentioned various functional fine particles are dispersed therein is used as a functional paint in accordance with the objects. The functional paint is applied onto a support or onto a resin layer containing a resin as a major component formed on the support and dried to form a layer containing the functional fine particles. Thereafter, the layer containing the functional fine particles is compressed to form a compressed layer of the functional fine particles, thereby to obtain the functional layer.

The liquid for dispersing the functional fine particles such as conductive fine particles or the like is not particularly limited, and various known liquids may be used. For example, as the liquid, saturated hydrocarbons such as hexane, aromatic hydrocarbons such as toluene and xylene, alcohols such as methanol, ethanol, propanol and butanol, ketones such as acetone, methyl ethyl ketone, methyl isobutyl ketone and diisobutyl ketone, esters such as ethyl acetate and butyl acetate, ethers such as tetrahydrofuran, dioxane and diethyl ether, amides such as N,N-dimethylformamide, N-methylpyrrolidone (NMP) and N,N-dimethylacetamide, halogenated hydrocarbons such as ethylene chloride and chlorobenzene, and others may be mentioned. Among these, liquids having a polarity are preferable, and in particular, alcohols such as methanol and ethanol, and amides such as NMP having an affinity with water are suitable because the dispersion is good without the use of a dispersant. These liquids can be used either alone or as a mixture of two or more kinds thereof. Further, a dispersant may be used depending on a kind of the liquid.

Also, water can be used as the liquid. If water is used as the liquid, the resin layer surface must be hydrophilic. The resin film and the resin layer are usually hydrophobic and are water-repellent, so that a uniform layer is not likely to be obtained. In the case described above, it is necessary to mix an alcohol with water or to make a hydrophilic surface of the support.

The amount of the liquid to be used is not particularly limited, and may be such that the dispersion liquid of the fine particles has a viscosity suitable for application. For example, 100 to 100,000 parts by weight of the liquid is used with respect to 100 parts by weight of the fine particles. The amount of the liquid may be suitably selected in accordance with kinds of the fine particles and the liquid.

The dispersion of the fine particles into the liquid may be carried out by a known dispersion technique. For example, the dispersion is carried out by the sand grinder mill method. At the time of dispersion, use of a medium such as zirconia beads is also preferable in order to loosen the agglomeration of the fine particles. Further, at the time of dispersion, one must take care not to mix impurities such as dust.

It is preferable that the dispersion liquid of the fine particles does not contain a resin. In other words, the amount of the resin is preferably zero. In the conductive layer, if the resin is not used, the contact between the conductive fine particles is not inhibited by the resin. Therefore, the conductivity among the conductive fine particles is ensured, and the electric resistance value of the obtained conductive layer is low. The resin may be contained in an amount that does not deteriorate the conductivity; however, the amount is extremely small as compared with the amount of the resin used as a binder resin in the prior art. For example, the upper limit of the resin contained in the dispersion liquid is less than 25 parts by volume with respect to 100 parts by volume of the conductive fine particles as represented by volume before dispersion. In the prior art, one has to use a large amount of the binder in order to obtain a mechanical strength of the coating layer, since strong compression is not carried out. If the resin is used in such an amount as to function as the binder, the contact between the conductive fine particles is inhibited by the binder, and the migration of electrons among the fine particles is inhibited to reduce the conductivity.

On the other hand, the resin has an effect to improve a haze of the conductive layer. However, in view of the conductivity, the resin is used preferably in a range of less than 25 parts by volume, more preferably in a range of less than 20 parts by volume, with respect to 100 parts by volume of the conductive fine particles as represented by volume before dispersion. Although the effect to improve the haze decreases, it is the most preferable not to use the resin in view of the conductivity.

In the functional layers using WO₃ fine particles, TiO₂ fine particles or the like, if the resin is not used, the contact between the fine particles is not inhibited by the resin, so that an improvement is achieved in various functions. The resin may be contained in an amount that does not inhibit the contact between the fine particles and does not deteriorate the various functions; however, the amount is, for example, about 80 parts by volume or less with respect to 100 parts by volume of the respective fine particles.

In the catalyst layer using Al₂O₃ fine particles or the like, if the resin is not used, the surface of the fine particles having a catalyst function is not covered with the resin. Therefore, the function as the catalyst is improved. In the catalyst layer, the larger the number of voids is in the inside of the layer, the larger the number of active points as the catalyst. In view of this point, it is preferable not to use the resin as much as possible.

Thus, for the functional layer it is preferable not to use the resin at the time of compression (namely, in the dispersion liquid of the functional fine particles); and even if the resin is used, it is preferably used in a small amount. The amount of the resin to be used may be suitably determined because the amount may vary to some extent depending on the object of the functional layer.

Various additives may be blended with the dispersion liquid of the fine particles within a range that satisfies the performance required in the function such as the conductivity or the catalyst action. For example, the additives such as an ultraviolet absorber, a surfactant, and a dispersant may be blended.

The support 1 is suitably flexible resin film that is not cracked even if the compression force of the compression step is increased. The resin film is lightweight and can be easily handled. Since a pressing step at a high temperature or a calcining step is not carried out in producing a film for transfer, the resin film may be used as the support.

As the resin film, for example, polyester film such as polyethylene terephthalate (PET), polyolefin film such as polyethylene and polypropylene, polycarbonate film, acrylic film, norbornene film (Arton manufactured by JSR Co., Ltd., or the like), and others may be mentioned.

Besides the resin film, cloth, paper or others may be used as the support.

The support 1, the functional layer 4, or the intermediate layer between the support 1 and the functional layer 4 preferably has transparency to the light used in exposure (for example, ultraviolet lays), for carrying out the method of forming functional layer pattern.

In the first form functional film, surface treatment of the support 1, the hard-coating layer 2, and the resin layer 3 will be described.

In the case of the first form functional films having the layer constitution of FIG. 2 and FIG. 3, a surface of the support 1 at the side of the resin layer 3 may be subjected to the release treatment in accordance with affinity of resin materials being composed of the resin layer 3 with the support 1, so that the release occurs between the support 1 and the resin layer 3 in the releasing step of pattern-transfer.

Further, as shown in FIG. 4 and FIG. 5, the hard-coating layer being low in adhesive properties with the support may be formed on the surface of the support (1). The hard-coating layer formed by using a silicone resin (for example, with the pencil hardness of larger than 4 H, preferably 5 H or harder) has low adhesive properties with the resin film such as PET, so that the support (1) can be easily released from the hard-coating layer (2). In this case, although the surface of the support (1) may be treated with a releasing agent, treatment with the releasing agent is not necessary.

The hard-coating layer 2 may be formed by applying a liquid in which a hard-coating material is dissolved into a solvent in accordance with the needs onto the support, drying the applied liquid and curing it.

The hard-coating material is not particularly limited, and various known hard-coating materials may be used. For example, a thermosetting hard-coating material such as silicone type, acrylic type and melamine type may be used. Among these, the silicone type hard-coating material is excellent in view of obtaining high hardness.

Further, an ultraviolet-curable type hard-coating material including a radical-polymerizing hard-coating material such as unsaturated polyester resin type and acrylic type, a cation-polymerizing hard-coating material such as epoxy type and vinyl ether type, and others may be used. In view of productivity such as curing reactivity, the ultraviolet-curable type hard-coating material is preferable. Among these, in views of curing reactivity and surface hardness, the acrylic type radical-polymerizing hard-coating material is desirable.

Application of the hard-coating material may be performed by a known method such as a roll coater including gravure cylinder, reverse, and Meyer bar, a slit die coater, or others.

After the application, the applied one is dried at a suitable range of temperature, and then cured. In the case of the thermosetting hard-coating material, by providing suitable heat, for example, the silicone type hard-coating material applied is cured by heating at about 60° C. to 120° for 1 minute to 48 hours. In the case of the ultraviolet-curable type hard-coating material, ultraviolet rays are irradiated for curing. The ultraviolet rays may be irradiated by irradiating ultraviolet rays for about 200 to 2000 mJ/cm² with the use of a lamp such as a xenon lamp, a low pressure mercury-vapor lamp, a middle pressure mercury-vapor lamp, a high pressure mercury-vapor lamp, a super high pressure mercury-vapor lamp, a metal halide lamp, a carbon arc lamp, or a tungsten lamp. A thickness of the hard-coating layer is, for example, about 0.5 to 20 μm, preferably about 2 to 5 μm.

An ultraviolet absorber may be contained in the hard-coating layer 2. As the ultraviolet absorber, various known ultraviolet absorbers may be used. For example, a salicylic acid type ultraviolet absorber, a benzophenone type ultraviolet absorber, a benzotriazole type ultraviolet absorber, a cyanoacrylate type ultraviolet absorber, and the like, may be mentioned. Further, various known additives such as a light stabilizer including a hindered-amine type light stabilizer and others, an antioxidant, an antistatic agent, a fire retardant, or the like, may be also contained in the hard-coating layer, in accordance with the needs. The ultraviolet absorber or various additives may be added into the hard-coating material, and may be applied.

In the case that the hard-coating layer 2 is formed on the support 1, respectively, the functional fine particles such as the conductive fine particles are not embedded in the hard-coating layer 2 at the time of compressing process after drying, thereby failing to provide good adhesive property between the fine particle layer 4 and the hard-coating layer 2.

Thus, in the first form in the present invention, it is preferable that the resin layer 3 comprising a soft resin as a main component is formed on the hard-coating layer 2 in advance, and that the liquid in which the functional fine particles are dispersed is applied onto the resin layer 3, dried and compressed. For the resin layer 3, softness of the degree by which the compressed layer 4 of the functional fine particles is formed with good adhesive properties is required. Consequently, the resin layer is preferably softer than, for example, pencil hardness of 2H. The degree of the softness required for the resin layer varies depending on a hardness of the hard-coating layer used, a kind or a particle diameter of the functional fine particles, compression force or the like.

For the resin layer 3 in the first form, soft resin may be used, and as the soft resin, for example, resin capable of obtaining relatively low hardness is used from acrylic resins, urethane resins, vinyl chloride resins, silicone resins or the like. The resin layer may contain fine particles such as silica for controlling hardness of the resin layer, or filler for coloring or absorbing ultraviolet rays, in a range that does not give bad influences to adhesive property. After compression, the soft resin layer may be cured by heat or ultraviolet rays.

Next, the resin layer 3 in the second form functional film will be described.

In the case of the second form functional film having the layer constitution of FIG. 2 and FIG. 3, it is preferable that the resin layer 3 has relatively high hardness, for example, pencil hardness of 2 H or harder and 4 H or softer, so that the release occurs between the resin layer 3 and the functional layer 4 in the releasing step of pattern-transfer. It is also preferable that adhesive properties between the support 1 and the resin layer 3 are high.

For the resin layer 3 in the second form, relatively hard resins may be used, and as such resins, resins capable of obtaining relatively high hardness are used from acrylic resins, urethane resins, vinyl chloride resins, silicone resins or the like. The resin layer may contain fine particles such as silica for controlling hardness of the resin layer. After compression, the resin layer may be cured by heat, ultraviolet rays, or the like.

By selecting the material or the hardness mainly of the resin layer 3, the functional film of the first form or the second form may be fabricated.

The resin of the resin layer 3 in the functional film of the first form and the second form is preferably insoluble into the liquid in which the functional fine particles are dispersed. In the conductive layer, if the resin layer is dissolved, the solution containing the resin comes around the conductive fine particles by capillary phenomenon and, as a result, raises the electric resistance value of the obtained conductive layer. In the catalyst layer also, the solution containing the resin comes around the fine particles having a catalyst function by capillary phenomenon to cause decrease in the catalyst function.

The dispersion liquid of the functional fine particles is applied onto the resin layer 3 or onto the support 1, and dried to form the layer containing the functional fine particles such as the layer containing the conductive fine particles.

Application of the dispersion liquid of the fine particles is not particularly limited, and may be carried out by a known method. For example, the application may be carried out by the application method such as the reverse roll method, the direct roll method, the blade method, the knife method, the extrusion nozzle method, the curtain method, the gravure roll method, the bar coat method, the dip method, the kiss coat method, the squeeze method, or the like. Further, the dispersion liquid may be allowed to adhere onto the support by atomizing, spraying, or the like.

The drying temperature is preferably about 10 to 150° C although it depends on a kind of the liquid used for dispersion. If the temperature is lower than 10° C., condensation of moisture in air is liable to occur, whereas if it exceeds 150° C., the resin film support will be deformed. Also, at the time of drying, one must take care not to allow impurities to adhere to the surface of the fine particles.

The thickness of the layer containing the functional fine particles such as the layer containing the conductive fine particles after application and drying may be about 0.1 to 10 μm, though it depends on the compression condition in the next step or on the usage of the each functional film such as the conductive film finally obtained.

Thus, if the functional fine particles such as the conductive fine particles are dispersed in the liquid and applied and dried, it is easy to form a uniform layer. If the dispersion liquid of the fine particles is applied and dried, the fine particles form a layer even if a binder is not present in the dispersion liquid. The reason why the layer is formed even in the absence of the binder is not necessarily clear; however, when the amount of the liquid decreases by drying, the fine particles gather by a capillary force. Further, it seems that, since they are the fine particles, the specific surface area is large and the agglomeration force is strong to form a layer. However, the strength of the layer at this stage is weak. Also, in the conductive layer, it has a high resistance value and has a large variation of the resistance value.

Next, the formed layer containing the functional fine particles such as the layer containing the conductive fine particles is compressed to obtain a compressed layer 4 of the functional fine particles such as the conductive fine particles. The compression improves the strength of the layer. Namely, the compression increases the number of contact points among the functional fine particles such as the conductive fine particles to increase the contact area. For this reason, the strength of the coating layer is increased. Since the fine particles are originally liable to be agglomerated, the compression makes a firm layer.

In the conductive layer, the strength of the coating layer increases and the electric resistance decreases. In the catalyst layer, the strength of the coating layer increases and the layer will be a porous layer, since the resin is not used or used in a small amount. Therefore, a higher catalyst function is obtained. In the other functional layers, the layer can be made into a layer having a high strength in which the fine particles are connected with each other, and also the filling amount of the fine particles per unit volume will be large, since the resin is not used or used in a small amount. For this reason, a higher function is obtained in each layer.

The compression is preferably carried out at a compression force of at least 44 N/mm². If it is carried out at a low pressure of less than 44 N/mm², the layer containing the functional fine particles such as the layer containing the conductive fine particles cannot be fully compressed and, for example, it is difficult to obtain a conductive layer being excellent in conductivity. A compression force of at least 135 N/mm² is more preferable, and a compression force of at least 180 N/mm² is still more preferable. According as the compression force is higher, the strength of the coating layer is improved, and the adhesive properties between the functional layer and the support will be improved. In the conductive layer, a layer being more excellent in conductivity is obtained, the strength of the conductive layer is improved, and the adhesive properties between the conductive layer and the resin layer will be firm. According as the compression force is raised, the pressure resistance of the apparatus must be raised, so that a compression force up to 1000 N/mm² is generally suitable.

Further, the compression is preferably carried out at such a temperature that the support is not deformed. If the support is the resin film, for example, it will be a temperature range below the glass transition temperature (secondary transition temperature) of the resin.

The compression is not particularly limited and may be carried out by sheet press or roll press; however, it is preferably carried out by means of a roll press machine. The roll press is a method in which the film to be compressed is sandwiched between rolls for compression and the rolls are rotated. The roll press is suitable because a high uniform pressure can be applied in the roll press, and the productivity of the roll press is higher than that of the sheet press.

The roll temperature of the roll press machine is preferably an ordinary temperature (an environment suitable for human work) from the viewpoint of productivity. If the compression is carried out in a heated atmosphere or with heated rolls (hot press), there will be a disadvantage such that the resin film is elongated when the compression pressure is increased. If the compression pressure is reduced in order to prevent the resin film from being elongated under heating, the mechanical strength of the coating layer decreases. In the conductive layer, the mechanical strength of the coating layer decreases and the electric resistance rises. It is also preferable to control the temperature so that the roll temperature may not rise by heat generation in the case where continuous compression is carried out by means of the roll press machine.

If there is a reason to reduce the adhesion of moisture to the fine particle surface as much as possible, the heated atmosphere may be adopted in order to reduce the relative humidity of the atmosphere; however, the temperature range is within a range such that the film is not easily elongated. Generally, it will be a temperature range below the glass transition temperature (secondary transition temperature). By taking the variation of humidity into account, it may be set at a temperature which is a little higher than the temperature that achieves the required humidity.

Here, the glass transition temperature of the resin film is determined by measuring the dynamic viscoelasticity, and refers to the temperature at which the dynamic loss of the main dispersion is at its peak. For example, with regard to PET film, its glass transition temperature is approximately around 110° C.

The roll of the roll press machine is preferably a metal roll because a strong pressure can be applied. Also, if the roll surface is soft, the fine particles may be transferred to the rolls at the compressing time, so that the roll surface is preferably treated with a hard film such as hard chromium, spraying film of ceramics, a film obtained by ionic plating of TiN, etc., DLC (diamond like carbon), or the like.

In this manner, the compressed layer 4 of the functional fine particles such as the conductive fine particles is formed. The thickness of the compressed layer of the functional fine particles such as the conductive fine particles may be about 0.1 to 10 μm, though it depends on the usage. Further, in order to obtain a thick compressed layer having a thickness of about 10 μm, a series of operations comprising application of the dispersion liquid of the fine particles, drying, and compression may be carried out repeatedly. Furthermore, in the present invention, it is of course possible to form the functional layers such as the conductive layer on both surfaces of the support. The functional layer such as the transparent conductive layer thus obtained shows a functionality such as an excellent conductivity or catalyst action, has a practically sufficient strength of the layer even though it is made without the use of the binder resin or with the use of a small amount of the resin such that it does not function as the binder. In the first form, the functional layer also has excellent adhesive property with the soft resin layer 3.

In the functional films of the first form and the second form in the present invention, the compressed layer 4 of the functional fine particles may comprise at least two different compressed layers of functional fine particles. Thus, the patterned functional multi-layer is formed.

In accordance with objects or usage of a multi-layer functional layer, multi-layer constitution may be accomplished by combining two or more functional layers having different functions. For example, the multi-layer functional layers for solar batteries, electroluminescent elements, electrochromic elements or the like may be obtained by combining two or more functional layers. For the solar batteries, specifically, a multi-layer constitution comprising a transparent conductive layer, a transparent insulating layer, a semiconductive layer of chalcopalrite structure composed of groups 1, 3 and 4 elements, and a metal electrode in this order, is illustrated.

For distributed D.C. operating electroluminescent elements, multi-layer constitution comprising a transparent conductive layer, an EL emission layer, a rear electrode in this order, is illustrated.

For permeable electrochromic elements, multi layer constitution comprising a transparent conductive layer, a first chromophoric layer, a dielectric layer, a second chromophoric layer and a transparent conductive layer in this order, is illustrated.

Besides these, various multi-layer constitutions in accordance with various usages may be considered.

The multi-layer constitution is obtained by performing repeatedly a series of operations comprising applying a dispersion liquid of corresponding functional fine particles, drying and compressing. Each layer that constitutes the multi-layer constitution is not necessarily a compressed layer. For example, in the case of the solar batteries, the transparent conductive layer, the transparent insulating layer and the semiconductive layer may be formed by compression and the metal electrode may be formed by vacuum deposition.

In the case where the first form and the second form of functional film are used in the second method of forming the functional layer pattern according to the present invention, the photosensitive adhesive layer 5 is formed on the functional layer 4. In the case where the first form and the second form of functional film are used in the first method of forming the functional layer pattern according to the present invention, it is preferred that the photosensitive adhesive layer 5 is formed on the functional layer 4. In the case where the first form and the second form of functional film are used for the first method of forming the functional layer pattern according to the present invention, if the adhesive layer is not formed on the functional film, it is suitable to provide the photosensitive adhesive layer on the substrate in advance. It is also preferred to provide the photosensitive adhesive layer 5 on the functional film and another photosensitive adhesive layer on the substrate.

The photosensitive adhesive layer 5 of the functional film or the photosensitive adhesive layer previously formed on the substrate is not particularly limited and various known photosensitive adhesives may be used, if the photosensitive adhesive layer has affinity to both the functional layer 4 of the functional film and a surface of the substrate, and can strongly glue the both. For example, an acrylic type adhesive and an epoxy type adhesive may be mentioned. In the third method of forming the functional layer pattern according to the present invention, the same photosensitive adhesive as described above may be used.

Further, the thermally curable adhesive which may be used in the third method of forming the functional layer pattern according to the present invention is not particularly limited and various known thermally curable adhesive may be used. Examples of the thermally curable adhesive include isocyanate type adhesive, silicone type adhesive and the like.

As the adhesive used for the adhesive layer 5 of the functional film in the present invention, adhesive capable of providing an adhesive layer having a tacky feeling by just applying an adhesive solution and drying, and providing a very hard cured layer by curing the adhesive layer by ultraviolet rays, are preferable. Softening or deterioration of the adhesive layer after sticking onto the transfer-object article is not preferable.

Thus, the present inventor also studied regarding adhesives satisfying such properties, and found out that following adhesive compositions are suitable as the adhesive used for the adhesive layer of the functional film in the present invention.
1. A photosensitive adhesive composition comprising a polymer resin component (P) having a glass transition temperature Tg of 30° C. or higher and a curable low molecular weight component (M) in a weight ratio P/M of 8/2 to 2/8.
2. The photosensitive adhesive composition according to 1., wherein the polymer resin component (P) is a solid at an ordinary temperature and the curable low molecular weight component (M) is a liquid at an ordinary temperature.
3. The photosensitive adhesive composition according to 1. or 2., wherein the polymer resin component (P) is an acrylic type resin and the curable low molecular weight component (M) is an acrylic type monomer.
4. The photosensitive adhesive composition according to any one of 1. to 3., wherein a photopolymerization initiator is further contained.

By that the polymer resin component is a solid at an ordinary temperature and that the curable low molecular weight component is a liquid at an ordinary temperature, a layer of adhesiveness having adhesiveness properties and being curable by providing stimulation can be easily formed. The layer of adhesiveness may have suitable adhesiveness properties.

As the polymer resin component, for example, an acrylic resin 103B (manufactured by Taisei Chemical Industries, Ltd.) may be mentioned. As the curable low molecular weight component, for example, a tri-or more functional acrylic type monomer such as KAYARAD GPO-303, KAYARAD TMPTA, KAYARAD THE-300 (those were manufactured by Nippon Kayaku Co., Ltd.) may be mentioned. As the photopolymerization initiator, various one may be used and, for example, KAYACURE DETX-S (manufactured by Nippon Kayaku Co., Ltd.) may be mentioned.

The adhesive composition may contain additives such as an ultraviolet absorber, an infrared absorber, etc., in accordance with the needs.

In the case that the adhesive layer 5 is formed in the functional film of the present invention, a surface of the adhesive layer may be protected until the time of being used by providing a release film onto the adhesive layer.

Further, the adhesive layer 5 may be formed in the functional film, by forming a photosensitive adhesive layer on a separately prepared release support subjected to the release treatment, and by laminating and gluing (adhering) the functional film with the release support on which the adhesive layer is formed, so that the adhesive layer is brought into contact with the functional layer 4 of the functional film. In this case, the release support is provided onto the adhesive layer at the same time of the formation of the adhesive layer 5, so that the surface of the adhesive layer is protected until the time of use.

In the present invention, it is also preferable that the compressed layer of the functional fine particles is subjected to heat treatment after formation of the compressed layer of the functional fine particles and before formation of the adhesive layer. By the heat treatment, internal stress remained,in the resin layer at the forming time of the compressed layer is relaxed so that corrosion resistance of the functional film against various materials or various solvents is improved.

Conditions for the heat treatment may be suitably selected. For relaxation of the internal stress, a temperature of the heat treatment is preferably 50° C. or higher, more preferably 80° C. or higher. Upper limit of the temperature of the heat treatment is, for example, normally 130° C. in the case that the resin film is used as the support. Heat treatment time is also normally in a range of 1 minute to 100 hours, preferably in a range of 10 minutes to 50 hours, further preferably in a range of 30 minutes to 25 hours. An atmosphere at the time of the heat treatment may be an atmosphere under vacuum, reduced pressure, air, nitrogen gas or inert gas such as argon.

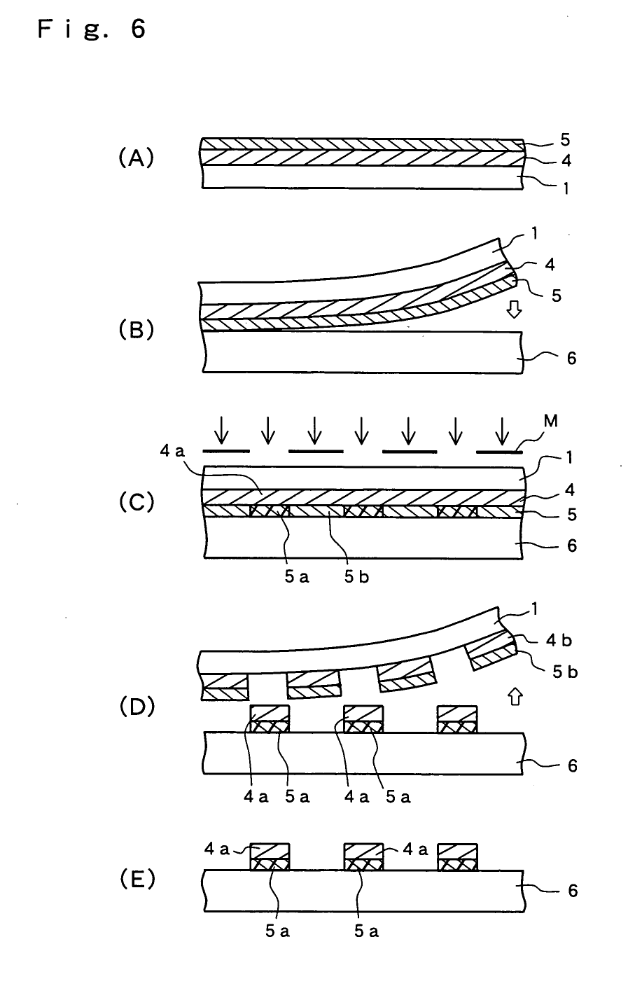

Next, the first method of forming the functional layer pattern according to the present invention will be described with reference to FIGS. 6(A) to 6(E). FIGS. 6(A) to 6(E) are schematic flowcharts showing the first method of forming the functional layer pattern.

At a preparatory step (A), the above-described functional film for transfer is prepared. FIG. 6(A) shows a functional film in which the functional layer 4 comprising a compressed layer of functional fine particles and the photosensitive adhesive layer 5 are formed on the support 1 in this order. The illustration of the intermediate layer is herein omitted.

In the functional film for transfer shown in FIG. 6(A), the photosensitive adhesive layer 5 is also formed. In the case where the photosensitive adhesive layer 5 is not formed, the photosensitive adhesive layer is provided on a substrate 6 prior to the following attachment step (B).

At the attachment step (B), the functional film for transfer is attached onto the surface of the substrate 6 through the photosensitive adhesive layer 5 so that the support 1 is outwardly oriented.

At an exposure step (C), the photosensitive adhesive layer 5 is pattern-exposed to an ultraviolet ray through a predetermined mask M. As a result of the pattern-exposure, the photosensitive adhesive layer 5 is patterned to have a cured region 5a by ultraviolet ray irradiation and an uncured region 5b without ultraviolet ray irradiation. A part 4a of the functional layer corresponding to the cured region 5a is adhered onto the surface of the substrate 6 through the cured adhesive layer 5a.

In the present invention, a photosensitive adhesive composition may be penetrated into gaps of the porous functional layer 4. The photosensitive adhesive composition penetrated into the functional layer 4 is cured by ultraviolet ray irradiation in the cured region 5a. Therefore, the adhesion between the functional layer 4a and the adhesive layer 5a is extremely reinforced in the cured region 5a. This effect obtained by the penetration of the adhesive composition into the functional layer is particularly effective in the case where the functional layer 4 is a conductive layer.

Although an ultraviolet ray is effective as a ray for exposure, an electron ray or an X-ray may also be used. The exposure time is appropriately selected depending on the photosensitivity of the photosensitive adhesive composition used for the adhesive layer 5 and the type of ray.

At a releasing step (D), the support 1 is released from the substrate 6. The functional layer 4a remains on the substrate 6 in the cured region 5a of the adhesive layer, whereas the functional layer 4b is released from the substrate 6 together with the support 1 in the uncured region 5b of the adhesive layer.

Specifically, the adhesion strength between the support 1 and the releasable functional layer 4 in the functional film for transfer is smaller than that between the cured adhesive layer 5a and the surface of the substrate 6 in the cured region 5a of the adhesive layer but larger than that between the uncured adhesive layer 5b and the surface of the substrate 6 in the uncured region 5b of the adhesive layer.

More specifically, in the case of the first form of functional film for transfer shown in FIGS. 2 and 3, the release occurs between the support 1 and the soft resin layer 3 in the cured region 5a of the adhesive layer at the release of the support 1. Since the adhesion between the functional layer 4 and the soft resin layer 3 is good, the release therebetween does not occur. Therefore, in the cured region 5a of the adhesive layer, the functional layer pattern 4a is provided on the surface of the substrate 6 through the adhesive layer 5a, and the resin layer 3 is present on the functional layer 4a.

In the case of the first form of functional film for transfer shown in FIGS. 4 and 5, since the adhesion between the support 1 and the hard-coating layer 2 is low, the release occurs between the support 1 and the hard-coating layer 2 in the cured region 5a of the adhesive layer at the release of the support 1. Therefore, the functional layer pattern 4a is provided on the surface of the substrate 6 through the adhesive layer 5a in the cured region 5a of the adhesive layer, and the resin layer 3 and the hard-coating layer 2 are present on the functional layer 4a.

If the functional layer pattern is formed using the first form of functional film for transfer as described above, the hard-coating layer 2 or the resin layer 3 in the functional film is exposed on the surface of the functional layer pattern 4a. The exposed hard-coating layer 2 or resin layer 3 may be even removed to expose the functional layer 4, depending on its application. The hard-coating layer 2 after transfer also serves as a protective-layer for the functional layer pattern 4a.

More specifically, in the case of the second form of functional film for transfer shown in FIGS. 2 and 3, since the adhesion between the functional layer 4a and the hard resin layer 3 is low in the cured region 5a of the adhesive layer at the release of the support 1, the release occurs between the resin layer 3 and the functional layer 4a. Therefore, in the cured region 5a of the adhesive layer, the functional layer pattern 4a is provided on the surface of the substrate 6 through the adhesive layer 5. The surface of the functional layer 4a is exposed. If the second form of functional film for transfer is used to form the functional layer pattern as described above, the functional layer pattern 4a in an exposed state is formed.

In the case where the uncured adhesive layer 5b partially remains on the substrate 6 in the uncured region 5b of the adhesive layer after the releasing step (D), it is suitable to carry out a step of removing the remaining uncured adhesive layer 5b as needed.

On the other hand, in the case where the uncured adhesive-layer 5b and the functional layer 4b partially remain on the substrate 6 in the uncured region 5b of the adhesive layer after the releasing step (D), it is suitable to carry out a step of removing the remaining functional layer 4b with the uncured adhesive layer 5b as needed. The removal may suitably be performed by, for example, washing with a solvent for dissolving the uncured adhesive layer.

In the above-described manner, the adhesive layer pattern 4a is formed on the surface of the substrate 6 through the adhesive layer 5 as shown in FIG. 6(E).

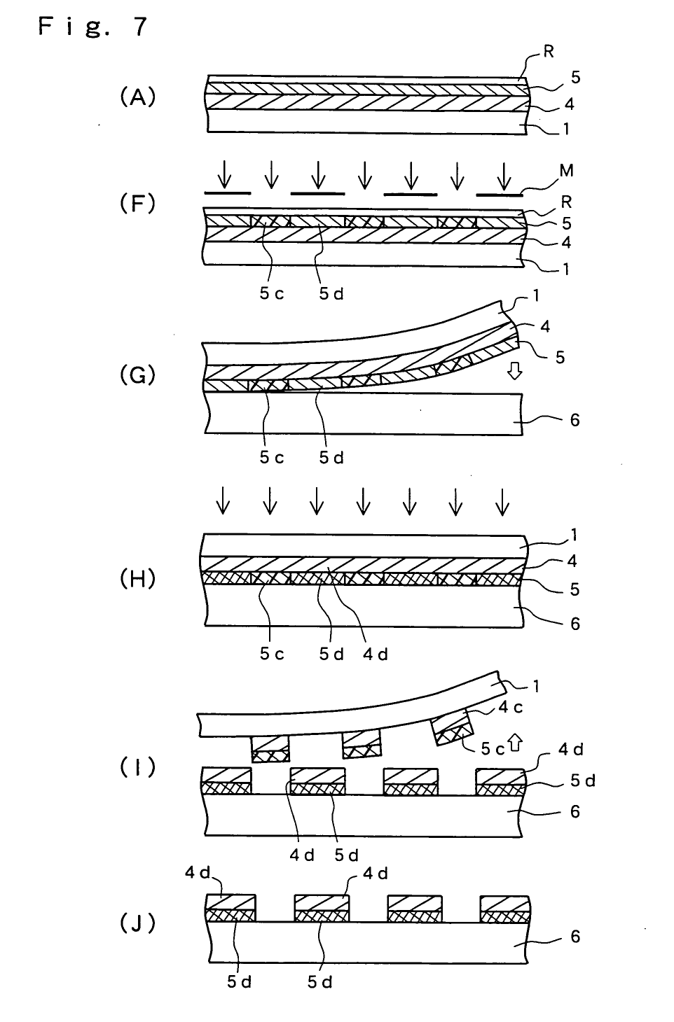

Next, the second method of forming the functional layer pattern according to the present invention will be described with reference to FIGS. 7(A) to 7(J). FIGS. 7(A) to 7(J) are schematic flowcharts showing the second method of forming a functional layer pattern.

At a preparatory step (A), the above-described functional film for transfer is prepared. FIG. 7(A) shows a functional film in which the functional layer 4 comprising a compressed layer of functional fine particles and the photosensitive adhesive layer 5 are formed on the support 1 in this order. The illustration of the intermediate layer is herein omitted.

At a pattern-exposure step (F), the photosensitive adhesive layer 5 is pattern-exposed to an ultraviolet ray through the mask M. As a result of the pattern-exposure, the photosensitive adhesive layer 5 is previously patterned to have a cured region 5c which no longer has any adhesiveness and an uncured region 5d maintaining the adhesiveness.

At an attachment step (G), the patterned functional film for transfer is attached onto the surface of the substrate 6 through the adhesive layer 5d in the uncured region so that the support 1 is outwardly oriented. Since the adhesive layer 5c in the cured region has lost the adhesiveness, it does not contribute to the adhesion between the functional film and the substrate 6.

At an exposure step (H) for adhesion, the adhesive layer 5d in the uncured region is exposed to an ultraviolet ray so as to be cured. A part 4d of the functional layer corresponding to the cured region 5d after the attachment step is adhered onto the surface of the substrate 6 through the cured adhesive layer 5d.

At a releasing step (I), the support 1 is released from the substrate 6. The functional layer 4d remains on the substrate 6 in the cured region 5d of the adhesive layer which is cured after the attachment step of the adhesive layer, whereas the functional layer 4c is released from the substrate 6 together with the support 1 in the precured region 5c of the adhesive layer.

Specifically, the adhesion strength between the support 1 and the releasable functional layer 4 in the functional film for transfer is smaller than that between the cured adhesive layer 5d and the surface of the substrate 6 in the cured region 5d of the adhesive layer which is cured after the attachment step of the adhesive layer but larger than that between the cured adhesive layer 5c and the surface of the substrate 6 in the precured region 5c of the adhesive layer. Substantially, the adhesive layer 5c and the surface of the substrate 6 are merely in contact with each other in the precured region 5c of the adhesive layer.

If the second method of forming the functional layer pattern is carried out using the first form of functional film for transfer, the hard-coating layer 2 or the resin layer 3 in the functional film is exposed on the surface of the functional layer pattern 4d, as in the case of the first method of forming the functional layer pattern.

If the second method of forming the functional layer pattern is carried out using the second form of functional film for transfer, the functional layer pattern 4d in an exposed state is formed as in the case of the first method of forming the functional layer pattern.

In the above-described manner, the functional layer pattern 4d is formed on the surface of the substrate 6 through the adhesive layer 5d as shown in FIG. 7(J).

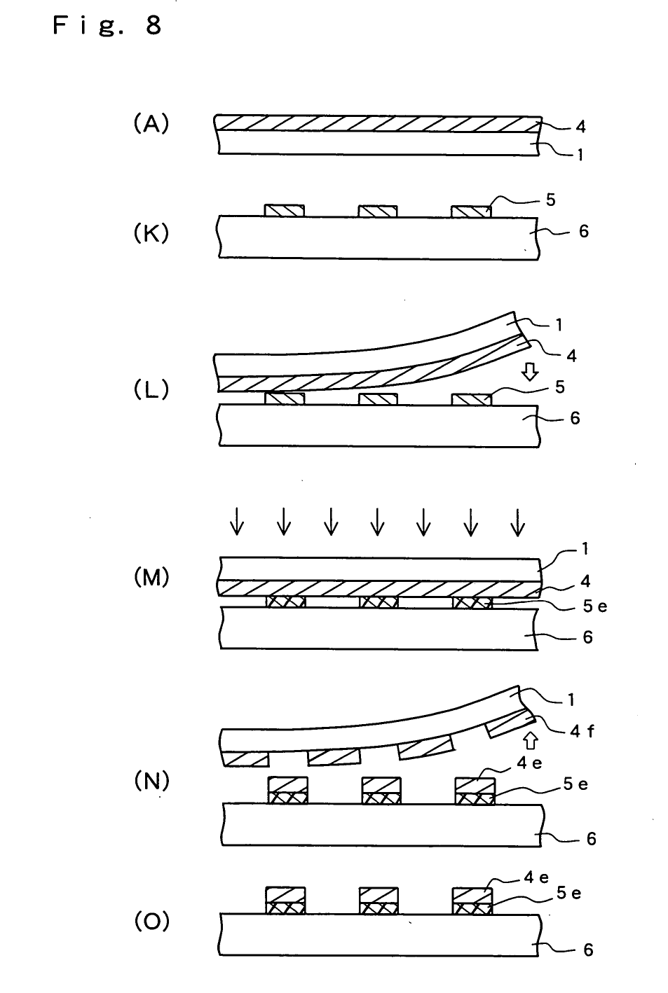

Next, the third method of forming the functional layer pattern according to the present invention will be described with reference to FIGS. 8(A) to 8(0). FIGS. 8(A) to 8(O) are schematic flowcharts showing the third method of forming the functional layer pattern.

At a preparatory step (A), the above-described functional film for transfer is prepared. FIG. 8(A) shows a functional film in which the functional layer 4 comprising a compressed layer of functional fine particles is formed on the support 1. The illustration of the intermediate layer is herein omitted.

At an application step (K) of a photosensitive adhesive layer, a photosensitive or thermally curable adhesive composition is applied onto the surface of the substrate 6 by screen printing or the like. After drying, the adhesive layer 5 is patterned.

At an attachment step (L), the functional film for transfer is attached onto the surface of the substrate 6 through the adhesive layer 5 formed on the surface of the substrate 6 so that the support 1 is outwardly oriented.

At an exposure step (M) for adhesion, in the case where the photosensitive adhesive is used, the photosensitive adhesive layer 5 is exposed to an ultraviolet ray to be cured so that the functional layer corresponding to the region where the adhesive layer is formed is adhered onto the surface of the substrate 6 through a cured adhesive layer 5e.

At the exposure step (M) for adhesion, in the case where the thermally curable adhesive is used, the thermally curable adhesive layer 5 is heated to be cured so that the functional layer corresponding to the region where the adhesive layer is formed is adhered onto the surface of the substrate 6 through the cured adhesive layer 5e.

At a releasing step (N), the support 1 is released from the substrate 6. As a result, a functional layer 4e corresponding to the region where the adhesive layer is formed remains on the substrate 6, whereas a functional layer 4f is released from the substrate 6 together with the support 1 in the region where the adhesive layer is not formed.

Specifically, the adhesion strength between the support 1 and the releasable functional layer 4 in the functional film for transfer is smaller than that between the cured adhesive layer 5e and the surface of the substrate 6 in the region where the adhesive layer is formed.

In the above-described manner, the functional layer pattern 4e is formed on the surface of the substrate 6 through the adhesive layer 5e as shown in FIG. 8(O).

### EXAMPLES

Hereinafter, the present invention will be more specifically described in accordance with some examples. However, the present invention is not limited to the following examples.

### Example 1

### The First Pattern Formation Method

As shown in FIG. 3, the second form of functional film for transfer including the resin layer 3, the functional layer 4, and the photosensitive adhesive layer 5 on the support 1 in this order was produced.

(Formation of the Resin Layer)

A silicone resin was used for a hard resin layer. An application solution for resin layer was prepared by mixing 100 parts by weight of an A solution and 300 parts by weight of a B solution of a Frescera N (fabricated by Matsushita Electric Works, Ltd.). After the PET film 1 having a thickness of 75 μm (HSL fabricated by Teijin Dupont Films Japan Limited) was subjected to a corona treatment, the application solution was applied onto the film 1 and then was dried and cured at 70° C. for 24 hours. As a result, the silicone resin layer 3 having a thickness of 0.7 μm was formed.

(Formation of the Functional Layer)

The ITO compressed layer 4 having a thickness of 1.0 μm was formed on the silicone resin layer 3 by using ITO fine particles having a primary particle diameter of 10 to 30 nm (fabricated by Dowa Mining Co., Ltd.). The operations thereof are described below.

300 parts by weight of ethanol were added to 100 parts by weight of the ITO fine particles, and thus obtained mixture was dispersed by means of a dispersion device with the use of zirconia beads as media. The obtained application liquid was applied onto the resin layer 3 by using a bar coater, and then was dried by hot air blow at 50° C. An ITO-containing coating film having a thickness of 1.7 μm was formed in this manner. The resultant film is referred to as an ITO film prior to compression.

First, a preliminary experiment was carried out so as to confirm a compression pressure.

A roll pressing machine including a pair of metal rolls (the surface of the roll was hard chrome plated), each having a diameter of 140 mm, was used so that the ITO film prior to compression was sandwiched between the pair of metal rolls to be compressed at a room temperature (23° C.) without rotating and heating the rolls. At this time, a pressure per unit length in a film width direction was 660 N/mm. Next, after releasing pressure, a length of a compressed portion in a film longitudinal direction was obtained to be 1.9 mm. Based on this result, it was found that the film was compressed at a pressure per unit area of 347 N/mm².

Next, the ITO film prior to compression, which was the same as that used in the preliminary experiment, was sandwiched between the metal rolls so as to be compressed under the above-described conditions. In this case, however, the rolls were rotated so that the film was compressed at a feed rate of 5 m/minute. In this manner, a compressed ITO film was obtained. A thickness of the ITO compressed layer 4 was 1.0 μm.

(Formation of the Photosensitive Adhesive Layer)

50 parts by weight of an ultraviolet ray curable resin solution SD-318 (fabricated by Dainippon Ink and Chemicals, Incorporated) and 136 parts by weight of methyl ethyl ketone were added to 100 parts by weight of an acrylic resin 103B (solid content: 50%; fabricated by Taisei Chemical Industries, Ltd.) so as to obtain an application solution for adhesive layer.

First, the application solution for adhesive layer was applied onto a release PET film S314 (fabricated by Teijin Dupont Films Japan Limited) which was silicone-treated. Then, the application solution was dried to form an adhesive layer having a thickness of 10 μm on the release PET film.

Next, the film, on which the ITO compressed layer 4 was formed, and the release PET film, on which the adhesive layer was formed, were laminated so that the ITO compressed layer 4 and the adhesive layer were in contact with each other. In this manner, the adhesive layer 5 was formed on the ITO compressed layer 4 so as to obtain a functional film for transfer. In FIG. 3, the illustration of the release PET film is omitted.

The functional film for transfer was produced as described above. By using this functional film for transfer, the patterning of the functional layer was performed onto a glass substrate as shown in FIG. 6. (Patterning of the functional layer onto a glass substrate) First, the glass substrate was subjected to a surface treatment. 0.9 parts by weight of acetic acid (1N) and 21 parts by weight of water were added to 100 parts by weight of a silane coupling agent KBM503 (fabricated by Shin-Etsu Chemical Co., Ltd.) to hydrolyze the silane coupling agent. 100 parts by weight of ethanol were added to 1 part by weight of the hydrolyzed silane coupling agent solution to obtain a surface treatment solution. The surface treatment solution was applied onto a glass plate by use of a swab and was then dried. The glass plate was left in an atmosphere at 110° C. for 5 minutes so as to permit the reaction between the silane coupling agent and the glass. Thereafter, an excessive silane coupling agent remaining on the glass plate was wiped away with a cloth impregnated with ethanol.

The release PET film of the obtained functional film for transfer was released so as to expose the adhesive layer 5. Then, the functional film for transfer was cut out into a rectangular of 10 cm by 26 mm. The rectangular functional film for transfer was adhered by a laminator so that the adhesive layer 5 was in contact with the surface-treated face of the glass substrate 6 [Step (B)].

After a two-sided adhesive tape was adhered onto an aluminum foil, they were cut so as to produce an aluminum adhesive tape having a width of 2 mm and a length of 10 cm as the mask M. Five aluminum adhesive tapes were adhered in parallel onto the surface of the PET film support 1 of the functional film attached onto the glass substrate 6 so that each distance between the tapes was 4 mm (that is, at a pitch of 6 mm). At this time, the adhesion was effectuated so that a longitudinal direction of the tape and a longitudinal direction of the functional film were parallel to each other.

An ultraviolet ray was radiated through the mask M on the side where the PET film support 1 was provided. As a result of the pattern-exposure, the photosensitive adhesive layer 5 was patterned into the cured region 5a with ultraviolet ray irradiation and the uncured region 5b without ultraviolet ray irradiation. The compressed layer 4a corresponding to the cured region 5a was adhered onto the surface of the substrate 6 through the cured adhesive layer 5a [Step (C)].

After the exposure, the PET film support 1 was released. The compressed layer 4a corresponding to the cured region 5a remained on the substrate 6 through the cured adhesive layer 5a, and the cured adhesive layer 5a was extremely hard. The compressed layer 4b corresponding to the uncured region 5b of the adhesive layer was released from the substrate 6 together with the support 1 [Step (D)]. Since a part of the adhesive layer 5b in the uncured region remained on the substrate 6, it was washed with methyl ethyl ketone so as to be removed.

In the above-described manner, four ITO compressed layer patterns 4a, each having a width of 4 mm, were formed on the surface of the substrate 6 through the adhesive layer 5a [Step (E)].

(Electric Resistance)

Testers were placed at two points, which were positioned 1 cm away from both ends of each ITO compressed layer pattern 4a in a longitudinal direction and in the center of a width direction (that is, a distance between the testers was 8 cm) so as to measure an electric resistance. For each of the ITO compressed layer patterns 4a, the electric resistance was 15 kΩ. There was no conduction between the four ITO compressed layer patterns 4a.

### Example 2

### The Second Pattern Formation Method

The second form of functional film for transfer was produced in the same manner as in Example 1 except that a thickness of the adhesive layer after application and drying was 8 μm by using an adhesive application solution having the following composition.

(Photosensitive Adhesive Application Solution)

92 parts by weight of the ultraviolet ray curable resin solution SD-318 (fabricated by Dainippon Ink and Chemicals, Incorporated) and 184 parts by weight of methyl ethyl ketone were added to 100 parts by weight of an acrylic resin 1BR-305 (solid content: 39.5%; fabricated by Taisei Chemical Industries, Ltd.) so as to obtain an application solution for adhesive layer.

The functional film for transfer was cut out into a rectangular of 10 cm by 32 mm. The rectangular functional film for transfer was used for patterning of the functional layer onto a polycarbonate substrate, as shown in FIGS. 7(A) to 7(J).

After a two-sided adhesive tape was adhered onto an aluminum foil, they were cut so as to produce an aluminum adhesive tape having a width of 4 mm and a length of 10 cm as the mask M. Five aluminum adhesive tapes were adhered in parallel onto the surface of a release PET film R so that each distance between the tapes was 2 mm (that is, at a pitch of 6 mm). At this time, the attachment was effected so that a longitudinal direction of the tape and a longitudinal direction of the functional film were parallel to each other. At the same time, margins where no tape was attached, each having a width of 2 mm, were left on the outer sides of the two outermost tapes of the five tapes.

An ultraviolet ray was radiated through the mask M on the side where the release PET film R was provided. As a result of the pattern-exposure, the photosensitive adhesive layer 5 was patterned into the cured region 5c with ultraviolet ray irradiation and the uncured region 5b without ultraviolet ray irradiation. In this manner, the adhesiveness of the cured adhesive layer 5c was lost in advance [Step (F)].

A polycarbonate substrate having a thickness of 1 mm was prepared.

The release PET film R of the patterned functional film for transfer was released to expose the adhesive layer 5. Then, the functional film was adhered by a laminator so that the adhesive layer 5 was in contact with the polycarbonate substrate 6 [Step (G)]. Since the adhesive layer 5c in the cured region had lost the adhesiveness, it did not contribute to the adhesion between the functional film and the substrate 6 whereas only the adhesive layer 5d in the uncured region contributed to the adhesion between the functional film and the substrate 6.

Next, an ultraviolet ray was radiated onto the side where the PET film support 1 was provided. As a result of the exposure, the adhesive layer 5d in the uncured region at the step (F) was cured. At the same time, the functional layer 4d corresponding to the region 5d cured after the attachment step (G) was adhered onto the surface of the substrate 6 through the cured adhesive layer 5d [the exposure step for adhesion (H)].

After the exposure, the PET film support 1 was released. The compressed layer 4d corresponding to the region 5d cured after the attachment step (G) remained on the substrate 6 through the cured adhesive layer 5d, and the cured adhesive layer 5d was extremely hard. The functional layer 4c was released from the substrate 6 together with the support 1 in the precured region 5c of the adhesive layer [Step (I)]. There was no adhesive layer remaining on the substrate 6.

In this manner, five ITO compressed layer patterns 4d, each having a width of 4 mm, were formed on the surface of the substrate 6 through the adhesive layer 5d (Step (J)).

(Electric Resistance)

Testers were placed at two points, which were positioned 1 cm away from both ends of each ITO compressed layer pattern 4d in a longitudinal direction and in the center of a width direction (that is, a distance between the testers was 8 cm) so as to measure an electric resistance. For each of the ITO compressed layer patterns 4d, the electric resistance was 15 kΩ. There was no conduction between the five ITO compressed layer patterns 4d.

### Example 3

### The Third Pattern Formation Method

(Production of the Functional Film for Transfer)

The second form of functional film for transfer including the resin layer 3 and the functional layer 4 on the support 1 in this order was produced as shown in FIG. 2. The resin layer and the functional layer were formed in the completely same manner as in Example 1. By using the functional film for transfer, the patterning of the functional layer onto the PET film substrate was conducted as shown in FIGS. 8(A) to 8(O).

(Photosensitive Adhesive Application Solution)

100 parts by weight of an acrylic resin 1BR-305 (solid content: 39.5%; fabricated by Taisei Chemical Industries, Ltd.) was mixed with 92 parts by weight of the ultraviolet ray curable resin solution SD-318 (fabricated by Dainippon Ink and Chemicals, Incorporated) so as to obtain an application solution for adhesive layer.

(Patterning of the Photosensitive Adhesive Layer onto the Substrate)

The application solution for adhesive layer was applied by screen printing onto a surface of the PET film HPE 6 having a thickness of 188 μm (fabricated by Teijin Dupont Films Japan Limited) so that a length was 10 cm, a width was 4 mm and a distance between the patterns was 3 mm (that is, at a pitch of 7 mm). The surface on which the solution was applied had been treated before the application of the solution so as to facilitate adhesion. Then, the solution was dried to form the patterned photosensitive adhesive layer 5 having a thickness of 8 μm [the step of forming the patterned adhesive layer (K)].

(Patterning of the Functional Layer)

The functional film for transfer was attached onto the surface of the substrate 6 through the adhesive layer 5 so that the support 1 was outwardly oriented [the attachment step (L)].

Next, an ultraviolet ray was radiated onto the side where the support 1 was provided. As a result of the exposure, the adhesive layer 5 was cured. At the same time, the ITO compressed layer 4e corresponding to the region where the adhesive layer 5 was formed was adhered onto the surface of the substrate 6 through the cured adhesive layer 5e [the exposure step (M)].

After the exposure, the support 1 was released. The ITO compressed layer 4e corresponding to the region where the adhesive layer 5 was formed remained on the substrate 6 through the cured adhesive layer 5e, and the cured adhesive layer 5e was extremely hard. The ITO compressed layer 4f was released from the substrate 6 together with the support 1 in the region where the adhesive layer was not formed [Step (N)].

In this manner, the ITO compressed layer patterns 4e having a width of 4 mm and a pitch of 7 mm, was formed on the surface of the substrate 6 through the adhesive layer 5e (Step (0)).

(Electric Resistance)

Testers were placed at two points, which were positioned 1 cm away from both ends of each ITO compressed layer pattern 4e in a longitudinal direction and in the center of a width direction (that is, a distance between the testers was 8 cm) so as to measure an electric resistance. For each of the ITO compressed layer patterns 4e, the electric resistance was 15 kΩ. There was no conduction between the five ITO compressed layer patterns 4e.

Each of the above-described examples shows the example where the functional film for transfer having a transparent conductive layer was produced by using ITO fine particles as inorganic fine particles so as to be used to form the transparent conductive layer pattern. As in the above-described examples, inorganic fine particles having various properties may be used to form functional films for transfer having various inorganic functional layers so as to form various functional layer patterns. Therefore, the above-described examples are merely exemplary in every regard, and therefore should not be read as limitative. Furthermore, any changes within the equivalent range of the appended claims are all fall within the scope of the present invention.

1. A substrate having a functional layer pattern formed thereon, the functional layer pattern being formed on the substrate through an adhesive layer, wherein the functional layer is a compressed layer of functional fine particles.

2. The substrate having a functional layer pattern formed thereon according to claim 1, wherein the functional layer is selected from the group consisting of: a conductive layer; an ultraviolet shielding layer; an infrared shielding layer; a magnetic layer; a ferromagnetic layer; a dielectric layer; a ferroelectric layer; an electrochromic layer; an electroluminescent layer; an insulating layer; a light-absorbing layer; a light selecting absorbing layer; a reflecting layer; a reflection preventing layer; a catalyst layer; and a photocatalyst layer.

3. A method of forming a functional layer pattern, comprising the steps of:
preparing a functional film for transfer having at least a functional layer on a support, the functional layer being releasable from the support and being a compressed layer of functional fine particles;
attaching the functional film for transfer onto a surface of the substrate through a photosensitive adhesive. layer so that the support is outwardly oriented;
pattern-exposing the photosensitive adhesive layer so as to pattern the photosensitive adhesive layer into a cured region and an uncured region, to adhere the functional layer corresponding to the cured region to the surface of the substrate through the cured adhesive layer; and
releasing the support from the substrate, so that in the cured region of the adhesive layer the functional layer remains on the substrate whereas in the uncured region of the adhesive layer the functional layer is released from the substrate together with the support.

4. The method of forming a functional layer pattern according to claim 3, wherein the functional film for transfer has the photosensitive adhesive layer on the functional layer.

5. The method of forming a functional layer pattern according to claim 3, wherein adhesion strength between the support and the releasable functional layer in the functional film for transfer is smaller than that between the adhesive layer and the surface of the substrate in the cured region of the adhesive layer, and is larger than that between the adhesive layer and the surface of the substrate in the uncured region of the adhesive layer.

6. The method of forming a functional layer pattern according to claim 3, in the case where a part of the uncured adhesive layer remains on the substrate in the uncured region of the adhesive layer after the step of releasing the support from the substrate, further comprising the step of removing the part of the uncured adhesive layer remaining on the substrate as needed.

7. The method of forming a functional layer pattern according to claim 3, in the case where a part of the uncured adhesive layer and a part of the functional layer remain on the substrate in the uncured region of the adhesive layer after the step of releasing the support from the substrate, further comprising the step of removing the part of the functional layer remaining on the substrate together with the remaining part of the uncured adhesive layer as needed.

8. The method of forming a functional layer pattern according to claim 3, wherein the functional film for transfer has an intermediate layer between the support and the functional layer.

9. The method of forming a functional layer pattern according to claim 3, wherein the compressed layer of functional fine particles in the functional film for transfer is obtained by applying a liquid, in which the functional fine particles are dispersed, onto the support or an intermediate layer provided on the support and then drying to form a functional fine particle-containing layer, and then compressing the functional fine particle-containing layer.

10. The method of forming a functional layer pattern according to claim 3, wherein the compressed layer of functional fine particles is obtained by compression at a compressive force of 44 N/mm² or larger.

11. The method of forming a functional layer pattern according to claim 3, wherein the compressed layer of functional fine particles is a transparent conductive layer.

12. A method of forming a functional layer pattern, comprising the steps of:
preparing a functional film for transfer having at least a functional layer on a support and a photosensitive adhesive layer provided on the functional layer, the functional layer being releasable from the support and being a compressed layer of functional fine particles;
previously pattern-exposing the photosensitive adhesive layer so as to pattern the photosensitive adhesive layer into a cured region no longer having adhesiveness and an uncured region maintaining adhesiveness;
attaching the patterned functional film for transfer onto a surface of the substrate through the adhesive layer in the uncured region so that the support is outwardly oriented;
exposing the adhesive layer in the uncured region for curing, to adhere the functional layer corresponding to the cured region after the attachment step onto the surface of the substrate; and
releasing the support from the substrate, so that in the cured region after the attachment step of the adhesive layer the functional layer remains on the substrate whereas in the precured region of the adhesive layer the functional layer is released from the substrate together with the support.

13. The method of forming a functional layer pattern according to claim 12, wherein adhesion strength between the support and the releasable functional layer in the functional film for transfer is smaller than that between the adhesive layer and the surface of the substrate in the cured region after the attachment step of the adhesive; layer, and is larger than that between the adhesive layer and the surface of the substrate in the precured region of the adhesive layer.

14. The method of forming a functional layer pattern according to claim 12, wherein the functional film for transfer has an intermediate layer between the support and the functional layer.

15. The method of forming a functional layer pattern according to claim 12, wherein the compressed layer of functional fine particles in the functional film for transfer is obtained by applying a liquid, in which the functional fine particles are dispersed, onto the support or an intermediate layer provided on the support and then drying to form a functional fine particle-containing layer, and then compressing the functional fine particle-containing layer.

16. The method of forming a functional layer pattern according to claim 12, wherein the compressed layer of functional fine particles is obtained by compression at a compressive force of 44 N/mm² or larger.

17. The method of forming a functional layer pattern according to claim 12, wherein the compressed layer of functional fine particles is a transparent conductive layer.

18. A method of forming a functional layer pattern, comprising the steps of:
preparing a functional film for transfer having at least a functional layer on a support, the functional layer being releasable from the support and being a compressed layer of functional fine particles;
forming a patterned adhesive layer on a surface of the substrate by application;
attaching the functional film for transfer onto a surface of the substrate through the adhesive layer formed on the surface of the substrate so that the support is outwardly oriented;
curing the adhesive layer, so that the functional layer in a region where the adhesive layer is formed is adhered onto the surface of the substrate through the cured adhesive layer; and
releasing the support from the substrate, so that in the region where the adhesive layer is formed the functional layer remains on the substrate whereas in a region where the adhesive layer is not formed the functional layer is released from the substrate together with the support.

19. The method of forming a functional layer pattern according to claim 18, wherein the adhesive is a photosensitive adhesive, and the adhesive layer is cured by exposure to light.

20. The method of forming a functional layer pattern according to claim 18, wherein the adhesive is a thermally curable adhesive, and the adhesive layer is cured by heating.

21. The method of forming the functional layer pattern according to claim 18, wherein adhesion strength between the support and the releasable functional layer in the functional film for transfer is smaller than that between the cured adhesive layer and the surface of the substrate in the region where the adhesive layer is formed.

22. The method of forming a functional layer pattern according to claim 18, wherein the functional film for transfer has an intermediate layer between the support and the functional layer.

23. The method of forming a functional layer pattern according to claim 18, wherein the compressed layer of functional fine particles in the functional film for transfer is obtained by applying a liquid, in which the functional fine particles are dispersed, onto the support or an intermediate layer provided on the support and then drying to form a functional fine particle-containing layer, and then compressing the functional fine particle-containing layer.

24. The method of forming a functional layer pattern according to claim 18, wherein the compressed layer of functional fine particles is obtained by compression at a compressive force of 44 N/mM² or larger.

25. The method of forming a functional layer pattern according to claim 18, wherein the compressed layer of functional fine particles is a transparent conductive layer.
